(19) United States
(12) Patent Application Publication
(10) Pub. No.: US 2016/0113073 A1
(43) Pub. Date: Apr. 21, 2016

(54) Re-Melting Furnace and Universal Joint, in Particular for the Electrode Rod Mounting of a Re-Melting Furnace

(71) Applicant: ALD VACUUM TECHNOLOGIES GMBH, Hanau (DE)

(72) Inventors: Ivaylo POPOV, Hanau (DE); Ralf OEHLER, Darmstadt (DE)

(73) Assignee: ALD Vacuum Technologies GmbH, Hanau (DE)

(21) Appl. No.: 14/787,799

(22) PCT Filed: Apr. 29, 2014
(86) PCT No.: PCT/DE2014/000220

§ 371 Date: Oct. 29, 2015

(30) Foreign Application Priority Data
Apr. 30, 2013 (DE) 10 2013 007 394.4

(51) Int. Cl. H05B 7/10; F27B 3/08; G01G 19/52; H05B 7/20; H05B 7/07; B22D 18/04; F27D 11/10

(52) U.S. Cl. CPC H05B 7/10; B22D 18/04; F27B 3/085; F27D 11/10; H05B 7/20; H05B 7/07; G01G 19/52

(57) ABSTRACT

A universal joint suspension system for a re-melting furnace is disclosed. The system is used to hold the electrode rod mounting including the consumable electrode cardanically in relation to the furnace body, thus allowing the mounting to be tipped in any direction. The fundamental concept of the system is that weighing cells are arranged in the bearings of one shaft of the universal joint bearing, the weighing cells determining the weight of the mounting and the parts suspended therein, such that the weight of the consumable electrode can be continuously derived from the determination process.

This application claims the priority of International Application No. PCT/DE201.4/000220, filed Apr. 29, 2014, and German Patent Document No. 10 201.3 007 394.4, filed Apr. 30, 2013, the disclosures of which are expressly incorporated by reference herein.

### BACKGROUND AND SUMMARY OF THE INVENTION

The invention relates to a re-melting furnace having a casting die disposed in a base frame, an electrode rod standing essentially upright and disposed over the casting die to which the end of a consumable electrode facing the casting die may be attached, an electrode rod mounting for the electrode rod that may be tipped in any direction relative to the base frame so as to be able to orient a consumable electrode held on the electrode rod in the casting die as coaxially as possible to the central axis of the casting die, with a cardanic positioning of the electrode rod mounting relative to the base frame being provided having two intersecting cardanic shafts, and having a weight sensor between the frame and the electrode rod mounting for determining the weight of a consumable electrode attached to the electrode rod.

Re-melting furnaces of this kind are used, for example, for re-melting. Various structures of such re-melting furnaces are available. In so-called vacuum arc re-melting (VAR), the consumption of the consumable electrode occurs in a vacuum. To this end, the casting die is located in a vacuum-tight tank. The consumable electrode dips into the casting die. Due to the application of a voltage between the consumable electrode and the casting die, an arc of light occurs at a high current between the lower end of the consumable electrode and the melt forming in the casting die, which causes the consumable electrode to gradually be consumed.

In an electro-slag re-melting process (ESR), the consumable electrode, for example, made of steel, dips into the slag bath of an open casting die that functions at the same time as an electrical resistor. The consumable electrode functions as a conducting electrode and melts away. Passing through the slag, sulfur and non-metallic inclusions are absorbed by the slag and precipitated later. This process occurs in air and not in a vacuum. The steel hardens under the slag in a copper casting die.

In order to control this melting process, the weight of the consumable electrode must be determined on an ongoing basis in such a way that it may be tracked based on its consumption.

In addition, an apparatus is necessary in order to be able to position the consumable electrode as centrally as possible in the casting die. The consumable electrode is a cylinder that is often not axially symmetrical, but rather has a bend. The consumable electrode is also frequently not welded to the electrode rod exactly coaxially to the electrode rod axis. This requires that the consumable electrode mounting be laterally tipped before beginning a melting process so that the consumable electrode is positioned as centrally as possible in the casting die.

To this end, DE 29 05 752 C3 describes an arrangement in which the consumable electrode mounting is mounted in a hanging fashion on a height-adjustable traverse. A reference platform is located on the traverse that is supported on the traverse via three weighing cells, which form the weight sensor. A base plate holding the electrode rod is pivotable relative to the reference platform around two axes running perpendicular to one another, so as to be able to orient the electrode rod.

The solution has already also been proposed of disposing the reference platform on the cover of a tank of a VAR system in which the casting die is located, with the reference platform resting on three weighing cells opposite the cover.

A carrier upon which an electrode rod mounting is constructed is cardanically mounted on this reference platform. The universal joint suspension allows the mounting to be laterally pivoted in any direction. The disadvantage in this arrangement lies in the fact that, upon a lateral tilting of the consumable electrode mounting, transverse forces are exerted on the weighing cells, which can distort measurement results. In order to prevent this, the platform is connected to the frame of the furnace via transverse control arms that support the transverse forces.

In order to achieve a high degree of measurement accuracy, a great deal of structural expense is therefore necessary. Moreover, a certain installation height must be made available because a certain installation height is required for the weight sensor, which generally comprises three weighing cells, and the cardanic mounting of the platform can only be realized thereabove.

An additional problem lies in the fact that the weighing cells tend to be freely mounted on the cover of the furnace tank or on a frame and are supported via pendulum supports on the universal joint suspension of the carrier. However, because the measurement result provided by the weighing cells is very temperature sensitive, a constant temperature of the weighing cells must be ensured for the duration of a melting process. However, this is scarcely possible in the case of freely mounted weighing cells, meaning that the possibility of distorted measurement results cannot be ruled out.

The object of the invention is to create a compact universal joint suspension having a weight sensor optionally comprising multiple weighing cells that also provides more precise measurement results.

To attain this object, the invention proposes that the weight sensor be disposed in one of the cardanic shafts.

Because, according to the invention, the weight sensor becomes a component of the universal joint suspension, the universal joint suspension does not require its own installation height, such that the installation height of the furnace as a whole can be reduced.

The temperature conditions in the universal joint suspension are more even due to its higher thermal mass, such that the measurement results are not distorted.

The weight sensor preferably comprises a plurality of weighing cells that are disposed in the shaft bearings of the respective cardanic shafts.

Each cardanic shaft is customarily mounted in a rotational fashion in two bearings, such that two weighing cells are sufficient to determine the weight of the consumable electrode mounting resting on the platform and the electrode rod connected thereto as well as of the consumable electrode itself. In the most simple case, the bearings may be structured as simple bearing bushes that form a journal bearing for the weighing cells.

The weighing cells are preferably disposed in the cardanic shaft whose spatial position relative to the base frame is not variable, with each weighing cell comprising only one measuring unit, with the orientation of the measuring unit being fixed relative to the base frame.

Thus, weighing cells are used that are sensitive in only one direction and that therefore do not detect forces acting perpendicular to said measurement direction.

Because the weighing cells are associated with the cardanic shaft whose spatial position does not change in response to tipping by the electrode rod mounting, the position of the weighing cells also does not vary such that their measurement direction relative to the base frame always remains constant, such that, in the case of a vertical orientation of the measuring unit, the weight to be determined can be immediately detected without correction.

A simple structure is obtained if one end of each weighing cell is attached in or on a foundation and that a bearing ring or a bearing bush is held in a rotational fashion on the other end protruding from the foundation.

Here, the foundation can be attached on the optionally cooled cover of a tank for accommodating the casting die.

The universal joint bearing comprises a cardanic ring in which four bearing rings or bearing bushes are distributed around its circumference, their axes running perpendicular to the axis of the cardanic ring, the bearing rings or bearing bushes being disposed coaxially to one another in groups of two.

A cardanic bearing with a relatively flat structure is thus obtained.

In this arrangement, the weighing cells are each surrounded by a bearing ring or a bearing bush that is disposed in the cardanic ring. Thus, the temperature of the weighing cells that are embedded in the cardanic ring is essentially determined by the constant temperature of the cardanic ring that protects the weighing cells from outside influences that would cause the temperature to vary, preventing the measuring results from being distorted by a change in temperature.

If necessary, the cardanic ring may be embodied as a hollow ring that is supplied with a cooling liquid, which supports a constant temperature of the weighing cells.

The invention relates not only to the re-melting furnace, but rather also to the cardanic joint per se.

The invention will be described in greater detail below with reference to an exemplary embodiment. A description of the furnace as a whole has been omitted because the furnace is structured essentially like the furnace in DE 101 06 966 C2 cited above.

### BRIEF DESCRIPTION OF THE DRAWINGS

FIG. 1 is a perspective view of a cardanically mounted electrode rod mounting of a re-melting furnace, with the universal joint bearing comprising weighing cells,

FIG. 2 is a section along the line A-A according to FIG. 1, and

FIG. 3 is a section along the line B-B according to FIG. 1.

### DETAILED DESCRIPTION OF THE DRAWINGS

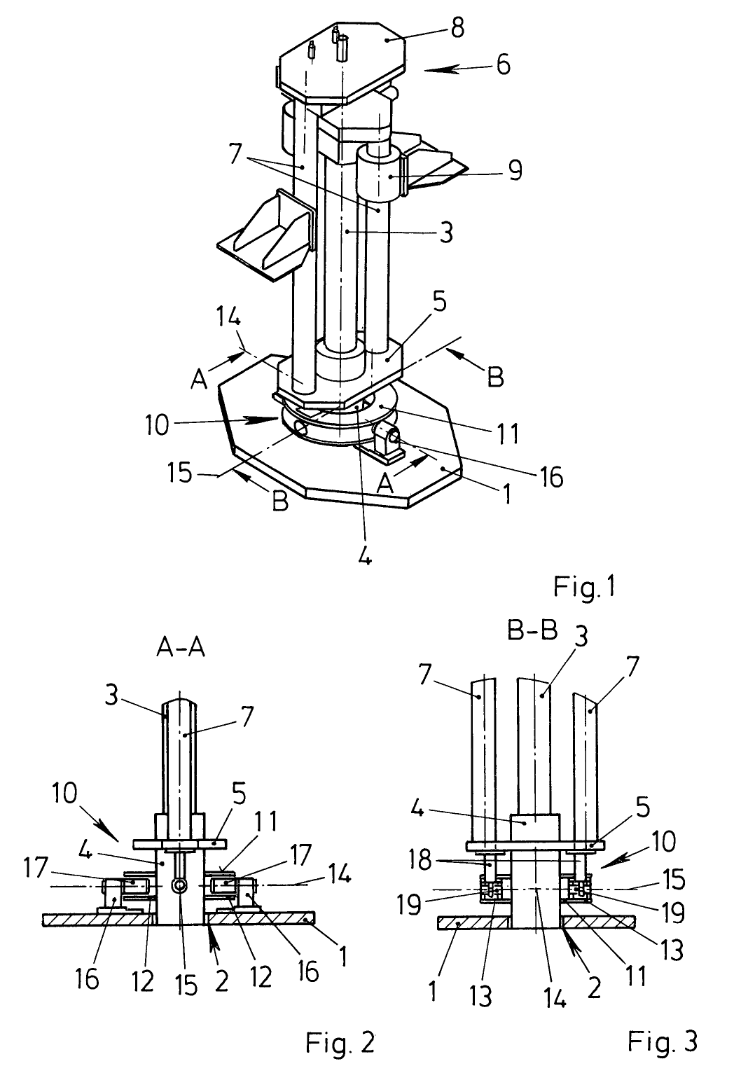

In FIG. 1, the cover 1 of a so-called furnace tank for a VAR system is shown in which a casting die is located. An opening 2 is located in the cover 1 (see FIGS. 2 and 3) through which an electrode rod 3 with a consumable electrode 4 fastened thereon is inserted, such that the electrode rod 3 dips into the casting die, which is not shown in greater detail here.

The cover 1 is part of the frame of the furnace system and therefore fixed in place, such that an electrode rod mounting 6 may be pivoted in all directions relative to the furnace frame and relative to the cover 1.

A carrying plate 5 is located above the cover 1 from which two guide rods 7 run vertically upward that end with their upper end on a traverse 8.

The electrode rod 3 is located between the guide rods 7. It is lowered and raised by means of a corresponding lift apparatus 9, which is only shown schematically here and not described in any greater detail, in order to control the arc-induced melting of the consumable electrode in the casting die.

As may furthermore be seen from FIGS. 2 and 3, a cardanic bearing 10 is located between the carrying plate 5 and the cover 1 that is comprised of a hollow cardanic ring 11. In the most simple case, the cardanic ring 11 is comprised of two circular rings disposed one above the other at a distance, with one inner and one outer circumferential wall optionally closing the space between the two circular rings. Four bearing rings 12, 13, each offset relative to the others by 90°, are located in this cardanic ring 11 and connect the two circular rings with one another, with the respective bearing rings 12 and 13 located opposite one another being coaxial to one another and apart from one another. Two opposite bearing rings 12 and 13 form a respective pair. The one pair of bearing rings 12 (see FIG. 2) serves to frame a cardanic shaft 14 fixed to the frame, while the other pair of bearing rings 13 (see FIG. 3) belongs to the cardanic shaft 15 that is fixed relative to the carrying plate 5.

The bearing rings may be bearing bushes for a journal bearing.

According to FIG. 2, a weighing cell 17 is located in each bearing ring 12 of the cardanic shaft 14 fixed to the frame that serves as a bearing core and on which the respective bearing ring 12 is rotationally mounted. The weighing cells 17 that are rotationally fixed are fastened to the cover 1 and protrude laterally therefrom.

The weighing cells 17 are a type of weighing cell having a fixed measuring direction, the measuring direction being vertically disposed such that the weighing cells 17 determine the weight of the electrode rod mounting 6 and the electrode rod 3 with the consumable electrode 4 welded thereto independently of any tipping of the electrode rod mounting 6. The weight of consumable electrode 4, which varies during the melting process can thereby be continuously calculated.

FIG. 3 shows the arrangement of the two bearing rings 13 in the cardanic shaft 15 fixed to the carrying plate. Two supports 18 insert radially therein from above that are fastened in the bolts 19 mounted in the bearing rings 13. The cardanic shaft 15 fixed to the carrying plate forms a transverse axis to the cardanic shaft 14 fixed to the frame such that the electrode rod mounting 6 may be tilted in all directions.

The two cardanic shafts 14, 15 run in one plane, resulting in a relatively small installation height of the universal joint bearing 10.

The present invention may be realized in a corresponding fashion in an ESR system. Because these systems do not comprise closed tanks, the cardanic ring is formed on a frame extending over the casting die.

### LIST OF REFERENCE CHARACTERS

1 Cover
2 Opening
3 Electrode rod
4 Consumable electrode
5 Carrying plate
6 Electrode rod mounting
7 Guide rods
8 Traverse
9 Lift apparatus
10 Universal joint bearing
11 Cardanic ring
12 Bearing rings
13 Bearing rings
14 Cardanic shaft
15 Cardanic shaft
16 Foundation
17 Weighing cell
18 Supports
19 Bolts

1.-10. (canceled)

11. A re-melting furnace, comprising:
a base frame;
a casting die disposed in the base frame;
an electrode rod standing essentially upright and disposed above the casting die, wherein a consumable electrode is attachable to an end of the electrode rod that faces the casting die; and
an electrode rod mounting, wherein the electrode rod is mounted in the electrode rod mounting and wherein the electrode rod mounting is pivotable in all directions relative to the base frame such that a consumable electrode attached to the electrode rod is orientable in the casting die coaxially with a central axis of the casting die;
wherein the electrode rod mounting has a universal joint bearing with two intersecting cardanic shafts and a weight sensor between the base frame and the electrode rod mounting for determining a weight of a consumable electrode attached to the electrode rod;
and wherein the weight sensor is disposed in one of the two cardanic shafts.

12. The re-melting furnace according to claim 11, wherein the weight sensor includes a plurality of weighing cells and wherein the plurality of weighing cells are disposed in a shaft bearing of the one of the two cardanic shafts.

13. The re-melting furnace according to claim 12, wherein a spatial position of the one of the two cardanic shafts relative to the base frame is not variable, wherein each of the plurality of weighing cells has only one measurement direction, and wherein an orientation of the measurement direction is fixed relative to the base frame.

14. The re-melting furnace according to claim 13, wherein each of the plurality of weighing cells has a first end and a second end, wherein each of the plurality of weighing cells is fastened on the respective first end in or on a foundation and wherein a bearing ring or a bearing bush of the shaft bearing is rotationally held on the respective second end which protrudes from the foundation.

15. The re-melting furnace according to claim 14, wherein the foundation is attached on a cover of a tank in which the casting die is disposed.

16. The re-melting furnace according to claim 11, further comprising a cardanic ring, wherein four bearing rings or bearing bushes are disposed in the cardanic ring and are distributed around a circumference of the cardanic ring, wherein respective axes of the four bearing rings or bearing bushes run perpendicular to an axis of the cardanic ring, and wherein respective groups of two of the bearing rings or bearing bushes are disposed coaxially to one another.

17. The re-melting furnace according to claim 15, wherein the cardanic ring is a hollow ring that is supplyable with a cooling liquid.

18. A universal joint bearing for a pivotable electrode rod mounting of a re-melting furnace, comprising:
two intersecting cardanic shafts; and
a weight sensor, wherein the weight sensor is disposed in one of the two cardanic shafts.

19. The universal joint bearing according to claim 18, wherein the weight sensor includes a plurality of weighing cells, wherein the plurality of weighing cells are disposed in a shaft bearing of the one of the two cardanic shafts, and wherein each of the plurality of weighing cells has only one measurement direction.

20. The universal joint bearing according to claim 18, further comprising a cardanic ring, wherein four bearing rings or bearing bushes are disposed in the cardanic ring and are distributed around a circumference of the cardanic ring, wherein respective axes of the four bearing rings or bearing bushes run perpendicular to an axis of the cardanic ring, and wherein respective groups of two of the bearing rings or bearing bushes are disposed coaxially to one another.
